(19) United States
(12) Patent Application Publication
(10) Pub. No.: US 2018/0327657 A1
(43) Pub. Date: Nov. 15, 2018

(54) PRESSURE ACTIVATED CURABLE RESIN COATED PROPPANTS WITH HIGH OIL PERMEABILITY

(71) Applicant: Fairmount Santrol, Inc., Chesterland, OH (US)

(72) Inventors: Ramanan Pitchumani, Missouri City, TX (US); Kanth Josyula, Sugar Land, TX (US); Abraham Rodriguez, Sugar Land, TX (US)

(21) Appl. No.: 15/774,669

(22) PCT Filed: Nov. 7, 2016
(86) PCT No.: PCT/US2016/060777

§ 371 Date: May 9, 2018

Related U.S. Application Data
(60) Provisional application No. 62/252,904, filed on Nov. 9, 2015.

(51) Int. Cl. C09K 8/80; C09K 8/66

(52) U.S. Cl. CPC C09K 8/805; E21B 43/267; C09K 8/66

(57) ABSTRACT

A curable resin coated proppant exhibiting high oil permeability when formed into a proppant pack includes an amino and/or hydroxyl functional nonionic surfactant in its curable resin coating. An optional non-aldehyde functional covalent crosslinking agent for the curable polymer resin can also be included in the curable resin coating. If so, the proppant will cure at downhole temperatures as low as 70° F. while simultaneously resisting damage premature curing due to heat and humidity above ground as well as premature consolidation downhole.

### CROSS-REFERENCE TO RELATED APPLICATION

This application claims priority to and all benefit of U.S. Provisional Patent Application Ser. No. 62/252,904, filed on Nov. 9, 2015, titled PRESSURE ACTIVATED CURABLE RESIN COATED PROPPANTS WITH HIGH OIL PERMEABILITY, the entire disclosure of which is fully incorporated herein by reference.

### BACKGROUND

In our commonly assigned patent disclosure Ser. No. 62/252,885 (atty. docket 17922/05030), the entire disclosure of which is incorporated herein by reference, we describe certain curable resin coated proppants which are formulated to (a) form strong, coherent proppant packs at downhole temperatures as low as 100° F. (˜38° C.), yet (b) resist clumping when stored and shipped above ground during hot summer months, and also (c) resist premature consolidation downhole, i.e., consolidation into a proppant pack before the proppants reaches its ultimate use location. This is accomplished, as described there, by including in the curable resin coatings of such proppants (1) an organofunctional compound comprising a polyol, a polyamine or a mixture of both and (2) a non-aldehyde functional covalent crosslinking agent for the curable polymer resin in these compositions which is also capable of chemically reacting with this organofunctional compound.

### SUMMARY

In accordance with a first embodiment of this invention, it has been found that curable resin coated proppants which also exhibit the same desirable properties of resisting clumping above ground as well as resisting premature consolidation downhole can be made in such a way that they can form proppant packs at downhole temperatures as low as 70° F. (˜21° C.) by including in the curable resin coatings of such proppants as they are made (1) a nonionic surfactant having reactive functionality due to one or more hydroxyl and/or amino groups and (2) a non-aldehyde functional covalent crosslinking agent for the curable polymer resin. Surprisingly, it has been further found in accordance with this invention that the inventive proppants made in this way also exhibit improved oil permeability relative to conventional curable resin coated proppants.

Thus, this invention in a first embodiment provides a curable resin coated proppant which comprises a proppant particle substrate and a curable resin coating on the proppant particle substrate, wherein the curable resin coating comprises the reaction product obtained when a molten mixture comprising a curable polymer resin, a conventional (aldehyde functional) curing agent for the curable polymer resin, a nonionic surfactant having reactive functionality due to one or more hydroxyl groups, one or more amino group or both, and a non-aldehyde functional covalent crosslinking agent for the curable polymer resin is coated onto the proppant particle substrate and then solidified and cooled in a manner so that the curable polymer resin remains curable.

In addition, this first embodiment of this invention also provides an aqueous fracturing fluid which is made with this curable resin coated proppant as well as a process for the hydraulic fracture of a geological formation comprising pumping this aqueous fracturing fluid into this geological formation.

In accordance with a second embodiment of this invention, it has been further found that even if a non-aldehyde functional covalent crosslinking agent is not included in curable resin coated proppants made in this way, these proppants nonetheless still exhibit improved oil permeabilities relative to conventional curable resin coated proppants.

Thus, this invention in a second embodiment provides a curable resin coated proppant which comprises a proppant particle substrate and a curable resin coating on the proppant particle substrate, wherein the curable resin coating comprises the reaction product obtained when a molten mixture comprising a curable polymer resin, a conventional (aldehyde functional) curing agent for the curable polymer resin, and a nonionic surfactant having reactive functionality due to one or more hydroxyl groups, one or more amino group or both is coated onto the proppant particle substrate and then solidified and cooled in a manner so that the curable polymer resin remains curable.

In addition, this second embodiment of the invention also provides an aqueous fracturing fluid which is made with this curable resin coated proppant as well as a process for the hydraulic fracture of a geological formation comprising pumping this aqueous fracturing fluid into this geological formation.

### DETAILED DESCRIPTION

### Definitions

This invention departs from earlier technology at least in that, in this invention, a nonionic surfactant having reactive functionality due to one or more amino groups and/or hydroxyl groups and an optional non-aldehyde functional covalent crosslinking agent for the curable polymer resin are included in the curable resin coating of a curable resin coated proppant. As further discussed below, whether or not any chemical reaction occurs among the different ingredients of this curable resin coating before the inventive proppant is used, or if so the nature of such chemical reaction and the products formed thereby, are unknown as of this writing. We do know, however, that the outermost resin layer of the inventive curable resin coated proppant still remains curable in the same way that the outermost resin layer of conventional curable resin coated proppants still remain curable. Therefore, we believe that, in the same way as occurs in conventional curable resin coated proppants, the curable resin layer of the inventive curable resin coated proppant at least contains some unreacted conventional (i.e., aldehyde functional) curing agent for the curable polymer resin so that additional curing of this outermost curable resin layer can occur when the proppant reaches its ultimate use location downhole.

So, for convenience, at least in some places, we describe the curable resin coating of the inventive curable resin coated proppant as “comprising” the various ingredients used to make this curable resin coating including both the conventional ingredients normally included in such coatings, i.e., the curable polymer resin, the conventional (aldehyde functional) covalent curing agent for this resin and conventional additives normally included in curable resin coatings of this type, as well as the additional ingredients provided by this invention, i.e., the amino and/or hydroxyl functional nonionic surfactant and the optional non-aldehyde functional covalent crosslinking agent. By this usage, we do not mean to say that some or all of these additional ingredients remain unreacted in the curable resin coating of the inventive proppant. Nor do we mean to say that all of these additional ingredients have reacted to form reaction products in this curable resin coating. Rather, we mean to say either of these situations is possible as is a combination of these situations.

Also, in various places in this disclosure, we indicate that the inventive proppants can form strong, coherent proppant packs. By “coherent,” we mean that these proppant packs resist proppant flowback, which is a common problem associated with proppant packs whose individual proppant particles are insufficiently bonded to one another.

### Proppant Particle Substrate

As indicated above, the pressure-activated curable resin coated proppants of this invention take the form of a proppant particle substrate carrying a coating of a curable resin coating which resists premature curing above ground and premature consolidation downhole.

For this purpose, any particulate solid which has previously been used or may be used in the future as a proppant in connection with the recovery of oil, natural gas and/or natural gas liquids from geological formations can be used as the proppant particle substrate. These materials can have densities as low as ˜1.2 g/cc and as high as ˜5 g/cc and even higher, although the densities of the vast majority will range between ˜1.8 g/cc and ˜5 g/cc, such as for example ˜2.3 to ˜3.5 g/cc, ˜3.6 to ˜4.6 g/cc, and ˜4.7 g/cc and more.

Specific examples include graded sand, bauxite, ceramic materials, glass materials, polymeric materials, resinous materials, rubber materials, nutshells that have been chipped, ground, pulverized or crushed to a suitable size (e.g., walnut, pecan, coconut, almond, ivory nut, brazil nut, and the like), seed shells or fruit pits that have been chipped, ground, pulverized or crushed to a suitable size (e.g., plum, olive, peach, cherry, apricot, etc.), chipped, ground, pulverized or crushed materials from other plants such as corn cobs, composites formed from a binder and a filler material such as solid glass, glass microspheres, fly ash, silica, alumina, fumed carbon, carbon black, graphite, mica, boron, zirconia, talc, kaolin, titanium dioxide, calcium silicate, and the like, as well as combinations of these different materials. Especially interesting are intermediate density ceramics (densities ˜1.8 to 2.0 g/cc), normal frac sand (density ˜2.65 g/cc), bauxite and high density ceramics (density ˜5 g/cc), just to name a few.

### Optional Fully-Cured Resin Coating

Although the curable resin coating of the inventive curable resin coated proppant of this invention can be directly applied to its proppant particle substrate, it may be desirable to interpose one or more intermediate coating layers between this curable resin coating and its proppant particle substrate.

As indicated above, it is well known in industry that the crush strength of a mass of proppants (i.e., a proppant pack) can be increased significantly by providing each proppant particulate, before the proppant is charged downhole, with its own coating of a fully-cured polymer resin. In this context, “fully cured” is used in its conventional sense, meaning that while curing may not be 100% complete nonetheless the vast majority of the curing has already occurred. “Fully-cured” is intended to distinguish these polymer resins from curable polymer resins (commonly referred to in industry as “B-stage” resins”), which although containing enough curing agent to cause full cure nonetheless remain substantially uncured.

In accordance with this optional feature, the ability of a fully cured resin coating to increase crush strength can be taken advantage of by applying one or more intermediate coating layers of a fully cured polymer resin to the proppant particle substrate before the curable resin coating of this invention is applied. As a result, proppant packs formed from the inventive curable resin coated proppant including this optional intermediate coating layer exhibit greater crush strengths compared with proppant packs formed from otherwise identical inventive proppants not including such intermediate coating layers.

To make this optional intermediate coating layer, any polymer resin which has previously been used, or which may be used in the future, for making fully cured resin coatings on proppant particle substrates for increasing their crush strength can be used. Normally, phenol aldehyde resins will be used for this purpose, especially novolac resins, since they work well and are relatively inexpensive.

In addition to polymer resin, a conventional curing agent for this polymer resin will also normally be used to make this optional intermediate coating layer. For this purpose, any curing agent which has been used in the past, or may be used in the future, to make fully cured resin coatings on proppants for increasing crush strength can be used.

As indicated above, in the vast majority of cases, the curable resin coating will be formed from a phenol aldehyde resin, and in particular a novolac resin. If so, the curing agent that will normally be used for curing this resin will be hexamethylenetetramine (“hexa” or “HMTA”), normally in aqueous solutions from about 10 wt. % to about 60 wt. %. As well appreciated in the art, hexa decomposes at elevated temperature to yield formaldehyde and by-product ammonia. In lieu of or in addition to hexa, other analogous curing agents can be used, examples of which include paraformaldehyde, oxazolidines, oxazolidinones, melamine reins, aldehyde donors, and/or phenol-aldehyde resole polymers.

These conventional curing agents are aldehyde functional in the sense that they form covalent crosslinks, specifically methylene crosslinks, between adjacent phenol moieties via the reaction of formaldehyde or analog to form pendant methylol groups which immediately condense to form ether intermediates which, in turn, immediately condense to form covalent methylene linkages. The following reaction scheme, in which hexa is used as the curing agent, illustrates this mechanism.

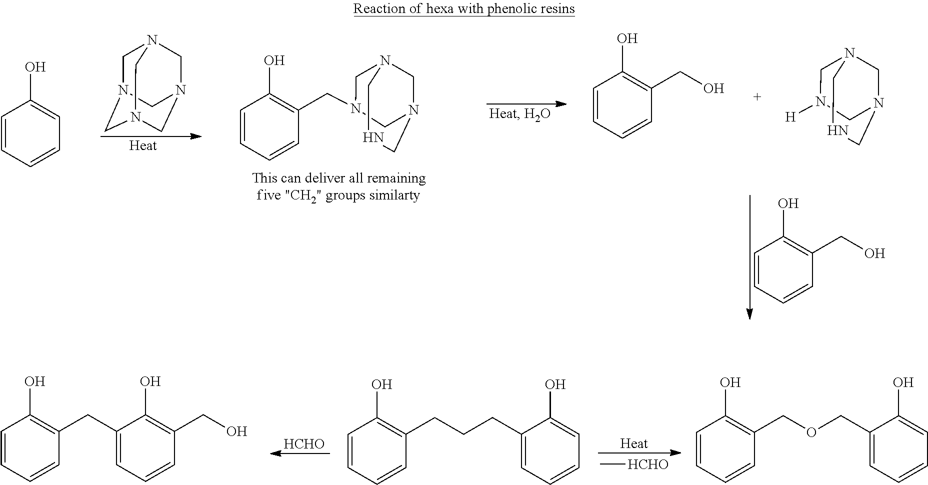

For convenience, therefore, we sometimes refer to these curing agents as “aldehyde functional curing agents.” Other times, we may refer to them as “conventional curing agents,” “conventional aldehyde functional curing agents” or the like.

In addition to conventional, aldehyde functional covalent curing agents, other ingredients which have, or may be, included in the fully cured resin coatings of conventional resin coated proppants can also be included in the intermediate fully cured resin coating layer of this invention. For example, additives referred to in industry as “toughening agents” can be added to reduce the brittle character of the fully cured resin coatings obtained, thereby reducing the tendency of these coatings to generate fines if the crush strength of the proppant is exceeded. Examples include polyethylene glycols such as PEG 400 to PEG 10,000, tung oil and polysiloxane based products such as HP2020 (a proprietary polysiloxane available from Wacker Chemie AG).

The amounts of ingredients that can be used for making these optional fully-cured resin coatings are conventional and well known in industry. For example, to produce each individual intermediate coating layer, the amount of novolac or other resin which is applied to the proppant particle substrate will generally be between about 0.1-10 wt. %, BOS (i.e., based on the weight of sand or other proppant particle substrate being used). More commonly, the amount of polymer resin applied will generally be between about 0.5 wt % to 5 wt. %, BOS. Within these broad ranges, polymer loadings of <5 wt. %, ≤4 wt. %, ≤3 wt. %, ≤2 wt. %, and even ≤1.5 wt. %, BOS are interesting. Most typically, the amount of polymer resin used to make each separate intermediate coating layer will be between about 0.10 wt. % and 1.5 wt. % BOS.

Similarly, if hexa is used as the curing agent, conventional amounts can be used, these amounts typically being between about 5 wt. % and 30 wt. %, more typically between about 10 wt. % and 20 wt. %, or even 12 wt. % to 18 wt. %, BOR (i.e., based on the amount of novolac or other curable resin in that particular coating layer).

In addition, if a toughening agent is used, conventional amounts can be added. For example, as much as 40 wt. % BOR and as little as 1 wt. % BOR of these toughening agents can be used. More commonly, the amount of toughening agent used will be about 1.5 to 25 wt. %, or even 2 to 10 wt. %, BOR.

### Curable Resin Coating

To make the curable resin coating of the inventive curable resin coated proppants, any polymer resin which has previously been used, or which may be used in the future, for making the curable resin coating of a curable resin coated proppant can be used. As in the case of the optional intermediate fully cured resin coatings mentioned above, phenol aldehyde resins and especially novolac resins will normally be used for this purpose, since they work well and are relatively inexpensive.

In this connection, it is well understood in industry that the same or essentially the same ingredients in essentially the same amounts as are used to make fully cured resin coatings in proppants are also used to make the curable resin coatings in proppants. The difference between these coatings primarily resides in the way they are made.

During manufacture, a fully cured resin coating is kept at an elevated curing temperature long enough to achieve essentially full cure of the resin. So, for example, when a hexa curing agent is used to cure a novolac resin, full cure can be accomplished in as little about 15 seconds if the resin is kept at a temperature of about 385° F. (˜196° C.). However, if the resin is kept at 275° F. (˜135° C.), full cure may take 5 minutes or longer. In contrast, a curable resin coating is typically maintained at lower temperature for a much shorter period of time to prevent any significant amount of curing from occurring. So, for example, if the same novolac resin and hexa curing agent mentioned above are used in the same amounts to make a curable resin coating, the hexa curing agent is not added until the temperature of the resin drops to a fairly low temperature, e.g., 250° F. (˜121° C.) or so. In addition, the resin/hexa curing agent combination is kept at this temperature only for a short period of time, e.g., about 5 to 15 seconds, before it is immediately quenched with water or otherwise cooled to prevent any additional curing from occurring.

The types and amounts of curable polymer resin and conventional aldehyde functional covalent curing agent that are used to make the curable resin coatings of the inventive proppants follow the same principle mentioned above, i.e., the same or essentially the same ingredients in essentially the same amounts as are used to make the above-described fully cured resin coatings can be used to make the curable resin coatings of the inventive proppants. Most typically, therefore, the amount of novolac or other curable resin used to make the curable resin coatings of the inventive proppants will be about 0.1 to 10 wt. %, more commonly about 0.3 to 5 wt % and even more typically % 0.5 to 1.5 wt. %, BOS. Similarly, the amount of hexa or other aldehyde functional curing agent added will normally be between about 10 to 25 wt. %, more commonly 12 to 20 wt. %, BOR (i.e., based on the weight of the curable polymer resin in this particular coating layer).

Improved Resistance against Premature Curing

Premature curing of the curable resin coating of a curable resin coated proppant is believed responsible for two different problems associated with this type of proppant, (1) clumping/agglomeration of the proppant above ground when stored in silos and shipped in rail cars during hot summer months and (2) premature consolidation downhole, i.e., consolidation into a proppant pack downhole before the proppant reaches its ultimate use location downhole.

In our earlier patent disclosure mentioned above, we found that these problems could be avoided in curable resin coated proppants which are capable of curing into strong, coherent proppant packs at temperatures as low as ˜100° F. (˜38° C.) by including in the curable resin coatings of these proppants (1) an organofunctional compound comprising a polyol, a polyamine or a mixture of both and (2) a non-aldehyde functional covalent crosslinking agent for the curable polymer resin which is also capable of chemically reacting with this organofunctional compound.

In accordance with the first embodiment of this invention, we found that these same problems can be avoided in curable resin coated proppants which are capable of curing into strong, coherent proppant packs at temperatures as low as ˜70° F. (˜21° C.) by including in the curable resin coatings of these proppants (1) a nonionic surfactant having reactive functionality due to one or more hydroxyl and/or amino groups and (2) a non-aldehyde functional covalent crosslinking agent for the curable polymer resin. In other words, we found that by including an amino and/or hydroxyl functional nonionic surfactant in the curable resin coating rather than a polyol or polyamine organofunctional compound, we could lower the approximate minimum temperature at which these proppants will cure to form strong, coherent proppant packs from ˜100° F. (˜38° C.) to ˜70° F. (˜21° C.).

As in the case of the curable resin coated proppant of our earlier patent disclosure, we also believe that the inventive curable resin coated proppant of this patent disclosure resists problems associated with premature curing because the non-aldehyde functional covalent crosslinking agent reacts with the curable polymer resin in the outermost resin coating of the proppant, at least its surface, to form a protective shell surrounding this outermost resin coating. As a result, the curable resin coatings of contiguous proppant particles are prevented from bonding to one another, even if they do undergo some premature curing. This, in turn, prevents clumping/agglomerating of these proppants during storage and transport above ground as well as premature consolidation of these proppants downhole. On the other hand, when these proppants reach their ultimate use locations downhole, the elevated pressures encountered there are sufficient to degrade this protective shell, thereby releasing the curable resin coatings underneath. As a result, contiguous proppant particles can bond to one another to form a strong, coherent proppant pack capable of resisting proppant particle displacement in a conventional manner. In a sense, therefore, these proppants can be considered to be “pressure-activated,” because it is the elevated pressures encountered downhole which are needed to cause these proppants to bond to one another.

As indicated above, as of this writing we do not know for sure whether the amino and/or hydroxyl functional nonionic surfactant and the non-aldehyde functional covalent crosslinking agent of this invention react with one another or any of the other ingredients in the curable resin coating of the inventive proppant. What we do know, however, as shown by the following working examples, is that the inventive proppants can form strong coherent proppant packs downhole at temperatures as low as 70° F. (˜21° C.) while simultaneously avoiding problems associated with premature curing such as premature consolidation downhole. In addition, we also know that the inventive curable resin coated proppants, like the curable resin coated proppants of our earlier patent disclosure mentioned above, also resist leaching of unreacted phenols, oligomers and other low molecular weight ingredients into aqueous fluids encountered downhole.

Still another advantage of the inventive curable resin coated proppant is a reduction in leaching of low molecular weight ingredients. During manufacture, curing of the curable resin of a curable resin coated proppant is terminated before it has proceeded to any significant degree. As a result, the curable resin coatings produced can contain significant amounts of unreacted phenol, oligomers and other low molecular weight ingredients. These ingredients tend to leach out of these curable resin coatings over time, which may be undesirable in some situations. In accordance with this invention, this leaching tendency is essentially prevented by the protective shell which forms surrounding the curable resin coating of each proppant particle.

### Nonionic Surfactant

As well known, a nonionic surfactant is a surfactant which does not ionize in aqueous solution because its hydrophilic group is of a non-dissociable type such as, for example, an alcohol, phenol, ether or amide. Most nonionic surfactants are made hydrophilic by the presence of a polyethylene glycol chain, which is made by the polycondensation of ethylene oxide. They are often called polyethoxylated nonionics. The hydrophobic (lipophilic) portion of a such a nonionic surfactant is typically made from an alkyl group, especially alkyl groups derived from fatty acids of natural origin, as well as alkyl benzenes.

Any nonionic surfactant having reactive functionality due to the presence of an amino group, a hydroxyl group or both can be used to make the inventive resin coated proppants. Most commonly, however, they will be made from polyethoxylated nonionics, especially those whose hydrophobic sections are based on alkyl benzenes. Polyethoxylated nonionics whose polyethylene glycol chains contain 4 to 40, more typically 5 to 30 or even 6 to 20 polymerized ethylene oxide units are more interesting. Such Polyethoxylated nonionics whose hydrophobic sections are based on fatty acids containing 6 to 32, 8 to 24 or even 12 to 16 carbon atoms and whose hydrophilic sections contain 6 to 40, 8 to 24 or even 12 to 16 polymerized ethylene oxide units are particularly interesting. Similarly, polyethoxylated nonionics whose hydrophobic sections are based on alkyl phenols whose alkyl groups contain 5 to 20, more typically 6 to 12, carbon atoms and whose hydrophilic sections contain 6 to 30, more typically 7 to 20 or even 8 to 16, polymerized ethylene oxide units are also particularly interesting. Such polyethoxylated nonionics whose alkyl groups are non-linear (i.e., in the form of branched chains) are of special interest, especially those in which two or more of the carbon atoms of the alkyl group are in branches.

Octylphenol ethoxylate, which has the following formula, is especially interesting.

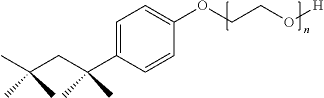

where n=9 to 10.

### Non-Aldehyde Functional Covalent Crosslinking Agent

As indicated above, in addition to a conventional aldehyde functional covalent crosslinking agent, a non-aldehyde functional covalent crosslinking agent is also include in the reaction mixture used to form the inventive curable resin coated proppants in accordance with the first embodiment of this invention. In this context, a “non-aldehyde functional covalent crosslinking agent” will be understood to refer to a crosslinking agent which causes a covalent crosslink to form between adjacent molecules of a curable polymer resin, which crosslink is not formed between adjacent phenol moieties via the mechanism of methylol formation followed by condensation of the methylol groups into ethers and the subsequent condensation of the ethers into methylene linkages.

Examples of such non-aldehyde functional covalent crosslinking agents include organic compounds which contain at least two of the following functional groups: epoxide, aldehyde, isocyanate, vinyl and allyl. Compounds which generate two functional groups such as anhydrides and carbodiamides can also be used. Particular examples of these non-aldehyde functional covalent crosslinkers include: PEG diglycidyl ether, epichlorohydrin, maleic anhydride, formaldehyde, glyoxal, glutaraldehyde, toluene diisocyanate, methylene diphenyl diisocyanate, 1-ethyl-3-(3-dimethylaminopropyl) carbodiamide, methylene bis acrylamide, and the like.

Especially interesting are the diisocyanates such as toluene-diisocyanate, naphthalenediisocyanate, xylene-diisocyanate, tetramethylene diisocyanate, hexamethylene diisocyanate, trimethylene diisocyanate, trimethyl hexamethylene diisocyanate, cyclohexyl-1,2-diisocyanate, cyclohexylene-1,4-diisocyanate, and diphenylmethanediisocyanates such as 2,4′-diphenylmethanediisocyanate, 4,4′-diphenylmethanediisocyanate and mixtures thereof.

In addition to these diisocyanates, analogous polyisocyanates having three or more pendant isocyantes can also be used. In this regard, it is well understood in the art that the above and similar diisocyanates are commercially available both in monomeric form as well as in what is referred to in industry as “polymeric” form in which each diisocyante molecule is actually made up from approximately 2-10 repeating isocyante monomer units.

For example, MDI is the standard abbreviation for the particular organic chemical identified as diphenylmethane diisocyanate, methylene bisphenyl isocyanate, methylene diphenyl diisocyanate, methylene bis (p-phenyl isocyanate), isocyanic acid: p,p′-methylene diphenyl diester; isocyanic acid: methylene di-phenylene ester; and 1,1′-methylene bis (isocyanato benzene), all of which refer to the same compound. MDI is available in monomeric form (“MMDI”) as well as “polymeric” form (“p-MDI” or “PMDI”), which typically contains about 30-70% MMDI with the balance being higher-molecular-weight oligomers and isomers typically containing 2-5 methylphenylisocyanate moieties.

For the purposes of this disclosure, it will be understood that we use “diisocyanate” in the same way as in industry to refer to both monomeric diisocyanates and polymeric isocyanates, even though these polymeric isocyanates necessarily contain more than two pendant isocyanate groups. Correspondingly, where we intend to refer to a simple monomeric diisocyanate, “monomeric” or “M” will be used such as in the designations “MMDI” and “monomeric MDI.” In any event, it will be understood that for the purposes of this invention, all such diisocyanates can be used as the covalent crosslinking agent, whether in monomeric form or polymeric form.

In addition to these diisocyanates, additional polyisocyanate-functional compounds that can be used as the covalent crosslinking agents of this invention are the isocyanate-terminated polyurethane prepolymers, such as the prepolymers obtained by reacting toluene diisocyanate with polytetramethylene glycols. Isocyanate terminated hydrophilic polyurethane prepolymers such as those derived from polyether polyurethanes, polyester polyurethanes as well as polycarbonate polyurethanes, can also be used.

In this regard, it is desirable when making the inventive resin coated proppants that the non-aldehyde functional covalent crosslinking agent be in liquid form when combined with the other ingredients of the coating composition. This is because this approach enhances the uniformity with which this crosslinking agent is distributed in the curable resin coating of the inventive proppants and hence the uniformity of the crosslinked layer or “shell” that is ultimately produced.

For this purpose, particular crosslinking agents can be selected which are already liquid in form. For example, MMDI, p-MDI and other analogous diisocyanates can be used as is, as they are liquid in form as received from the manufacturer. Additionally or alternatively, the crosslinking agent can be dissolved in a suitable organic solvent. For example, many aliphatic diisocyanates and polyisocyanates are soluble in toluene, acetone and methyl ethyl ketone, while many aromatic diisocyanates and polyisocyanates are soluble in toluene, benzene, xylene, low molecular weight hydrocarbons, etc. Dissolving the isocyanate in an organic solvent may be very helpful, for example, when polymeric and other higher molecular weight diisocyanates are used.

Another especially interesting class of compounds that can be used as the non-aldehyde functional covalent crosslinking agent of this invention are the polyepoxides, i.e., compounds which contain (or are capable of reacting to contain) two or more epoxy groups. Examples include PEG diglycidyl ether, epichlorohydrin, bisphenol A diglycidyl ether and its prepolymers, etc.

In a particularly interesting approach in connection with this first embodiment of the invention, the particular non-aldehyde functional covalent crosslinking agent used is capable of reacting with the amino and/or hydroxyl group of the amino and/or hydroxyl functional nonionic surfactant used in the same embodiment. For example, a diisocyante can be used as the non-aldehyde functional covalent crosslinking agent while a polyethoxylated nonionic can be used as the amino and/or hydroxyl functional nonionic surfactant, since the terminal hydroxyl group on the polyethylene glycol chain of the polyethoxylated nonionic should be capable of reacting with an isocyanate moiety of the diisocyanate. As indicated above, we have not confirmed as of this writing whether such a reaction actually occurs. What we have confirmed, however, is that the combination of polyethoxylated nonionics on the one hand and diisocyante non-aldehyde functional covalent crosslinking agents on the other hand provide exceptionally good properties in the resin coated proppants of this embodiment of the invention.

### Optional Catalyst for Crosslinking Agent

In those embodiments of this invention in which a non-aldehyde functional covalent crosslinking agent is included in the curable resin coating of the inventive proppant, a catalyst for this crosslinking agent can also be included in this curable resin coating.

Common types of catalysts or accelerators that can be used for this purpose include acids such as different sulfonic acids and acid phosphates, tertiary amines such as Polycat 9 [bis(3-dimethylaminopropyl)-n,n-demethylpropanediamine] and triethylenediamine (also known as 1,4-diazabicyclo[2.2.2]octane), and metal compounds such as lithium aluminum hydride and organotin, organozirconate and organotitanate compounds. Examples of commercially available catalysts include Tyzor product line (Dorf Ketal); NACURE, K-KURE and K-KAT product lines (King Industries); JEFFCAT product line (Huntsman Corporation) etc. Any and all of these catalysts can be used to accelerate the covalent crosslinking reaction occurring in the inventive technology.

### Optional Organofunctional Compound

In accordance with yet another feature of the first embodiment of this invention, the same polyol and/or polyamine organofunctional compounds that are included in the curable resin coated proppants of our earlier patent disclosure mentioned above are included in the curable resin coatings of the inventive proppants of this patent disclosure as optional ingredients. In accordance with this feature of the invention, it has been found that the combination of the amino and/or hydroxyl functional nonionic surfactant of this invention and the polyol and/or polyamine organofunctional compounds of our earlier invention, when used together in the same curable resin coating also containing a non-aldehyde functional covalent crosslinking agent, provides curable resin coated proppants capable of forming proppant packs which are exceptionally strong and robust.

Suitable polyamines that can be used for this purpose include any polyamine containing two or more primary amino groups, i.e., (—NH2). Both monomeric polyamines such as ethylene diamine, 1,3-diaminopropane and hexamethylenediamine can be used, as well as polymeric polyamines such as polyethyleneimine. These polyamines desirably have molecular weights which are low enough to dissolve in suitable carrier liquids and may also be liquids at room temperature, i.e., 20° C. These polyamines also may contain 2-15 carbon atoms, more typically 2-10, or even 2-8, carbon atoms and 2-5, more typically 3-5, primary amino groups. Liquid polyamines having 3-6 carbon atoms are interesting.

The polyols that can be used for this purpose include any polyol containing two or more pendant hydroxyl groups. Both monomeric polyols such as glycerin, pentaerythritol, ethylene glycol and sucrose can be used, as can polymeric polyols such as polyester polyols and polyether polyols such as polyethylene glycol, polypropylene glycol, and poly(tetramethylene ether) glycol.

These polyols may have molecular weights which are low enough to dissolve in suitable carrier liquids and may also be liquids at room temperature, i.e., 20° C. These polyols may contain 2-15 carbon atoms, more typically 2-10, or even 2-8, carbon atoms and 2-5, more typically 3-5, pendant hydroxyl groups. Liquid polyol having 3-6 carbon atoms and 2-4 pendant hydroxyl groups are especially interesting, as are liquid polyols having 3-6 carbon atoms and 3-5 pendant hydroxyl groups. Particular examples of liquid polyols which are useful for this invention include ethylene glycol, propylene glycol, butylene glycol, pentylene glycol, glycerol, trihydroxy butane and trihydroxy pentane.

In a particularly interesting aspect of this feature, the optional polyol and/or polyamine organofunctional compounds is a polyol which exhibits a plasticizing effect on the curable polymer resin of its curable resin coating. In other words, the polyol and/or polyamine organofunctional compound is a plasticizer for the curable polymer resin. Particular examples include polyols based on polyethylene glycol and polypropylene glycol such as the plasticizers mentioned above, i.e., polyethylene glycols exemplified by PEG 400 and PEG 10,000, which are known to plasticize a wide variety of different polymer resins such as phenol aldehyde resins and especially novolac resins.

### Proportions

The amounts of resin coatings that can be applied to the proppant particle substrate when practicing this invention are conventional.

For example in conventional curable resin coated proppants containing only a single resin coating, when coated on a sand proppant particle substrate, the amount of curable resin coating is typically 0.5 to 20 wt. %, more typically 0.75 to 10 wt. %, even more typically 1 to 4 wt. %, BOS (i.e., based on the weight of the sand). In contrast, in conventional resin coated proppants containing one, two or more intermediate layers of a fully cured resin coating and a top coat of a curable resin coating, when coated on a sand proppant particle substrate, the amount of fully cured resin in each intermediate layer is typically 0.2 to 20 wt. %, more typically 0.5 to 5 wt. %, even more typically 0.75 to 2 wt. %, BOS, while the amount of curable resin in the top coat is typically 0.2 to 10 wt. %, more typically 0.5 to 5 wt. %, even more typically 0.75 to 2 wt. %, BOS. When conventional curable resin coated proppants are made with something other than sand as the proppant particle substrate, corresponding amounts of curable resin coatings and fully cured resin coating are used. In practicing this invention, these same amounts of curable resin coatings, as well as fully cured resin coatings, can be used.

The amount of amino and/or hydroxyl functional nonionic surfactant included in the curable resin coating of the inventive proppant should be sufficient to achieve a significant enhancement in the properties make possible by this invention. So in the case of both embodiments of this invention, the amount used should be sufficient to increase the permeability of a pack of the inventive proppant to oil after the pack has been exposed to aqueous liquid. In addition, in the first embodiment of this invention in which a non-aldehyde functional covalent crosslinking agent is also included in the curable resin coating of the inventive proppant, the amount of amino and/or hydroxyl functional nonionic surfactant used should also be sufficient to achieve a noticeable increase in the resistance to clumping above ground and the resistance to premature consolidation downhole exhibited by the inventive proppant relative to conventional resin coated proppants. In general, this means that the amount of this nonionic surfactant used will typically be about 0.1 to 5 wt. %, BOS (based on the weight of the sand in the inventive proppant), more typically, about 0.15 to 2 wt. % or even about 0.2 to 0.6 wt. %, BOS.

The amount of optional non-aldehyde functional covalent crosslinking agent that can be used to make the inventive proppant in accordance with the first embodiment of this invention should be enough to participate with the amino and/or hydroxyl functional nonionic surfactant in achieving a noticeable increase in the resistance to clumping and premature consolidation exhibited by these proppants relative to their conventional counterparts. Thus, it is contemplated that the amount of non-aldehyde functional covalent crosslinking agent used will normally be 0.1 to 5 wt. %, more typically 0.15 to 2 wt. %, even more typically 0.2 to 1.0 wt. %, or even 0.3 to 0.7 wt. %, BOS. In addition, if an optional polyol and/or polyamine organofunctional compound capable of reacting with this covalent crosslinking agent is also included in the system, then the amount of optional non-aldehyde functional covalent crosslinking agent used should also desirably be at least enough to react with all of this organofunctional compound on a molar basis as well.

In those embodiments in which a polyol and/or polyamine organofunctional compound is included in the curable resin coating of the inventive proppant, the amount used will typically be on the order of about 5 wt. % to 40 wt. % BOR, i.e., based on the weight of the curable polymer resin in this curable resin coating. More typically, the amount of this organofunctional compound will be about 10 wt. % to 25 wt. %, about 12 wt. % to 20 wt. % or even about 13 wt. % to 18 wt. %, on this basis.

When the inventive curable resin coated proppants are made with something other than sand as the proppant particle substrate, corresponding amounts of these ingredients are used.

### Method of Manufacture

As indicated above, the normal way in which the resin coating of a conventional resin coated proppant is made is to mix the novolac or other resin forming the resin coating in particulate form with the proppant particle substrate which has previously been heated to a temperature which is high enough to cause the resin to melt and hence coat the individual proppant substrate particles. Hexa or other aldehyde functional curing agent is then added with continued vigorous mixing. If a fully cured resin coating is desired, this procedure is carried out at a temperature which is high enough and for a period of time which is long enough to achieve full cure of the resin. If only a partially cured resin coating is desired, i.e., a curable resin coating, then this procedure is carried out at a temperature which is low enough and for a period of time which is short enough to prevent the resin from curing to any significant degree. When multiple resin coatings are desired, the intermediate coating layers are almost always made from fully cured resins. So the way such proppants are typically made is by carrying out the above process repeatedly, since the temperature of the proppant automatically decreases with each additional coating layer as the latent heat in the proppant particle substrate is consumed in melting the resin forming each additional coating layer.

This same general procedure can be used to make the inventive proppants, with the additional ingredients of this invention, i.e., the amino and/or hydroxyl functional nonionic surfactant, the optional non-aldehyde functional covalent crosslinking agent, the catalyst for this non-aldehyde functional covalent crosslinking agent and the optional toughening agent, being incorporated into the outermost resin coating of this product in such a way that they become an integral part of this outermost resin coating. This can be done, for example, by adding these additional ingredients to the other ingredients of the curable resin coating, i.e., the curable polymer resin, the conventional curing agent for this curable polymer resin and any other additive that might also be present, before it has a chance to solidify—in other words, while it is still molten. As a result, these ingredients as well as reaction products that form from these ingredients become an integral part of this outermost curable resin coating.

This is not to say that that each of these additional ingredients is uniformly or homogenously distributed throughout the entire mass of this curable resin coating. Rather, we are only saying that applying these additional ingredients while the curable resin coating is still molten enables some type of reaction to occur which causes a significant change in the properties of the curable resin coated proppants obtained. In contrast, applying these additional ingredients, and especially the amino and/or hydroxyl functional nonionic surfactant, to the outside surface of this outermost curable resin coating after it has solidified will not achieve the same results, since these additional ingredients will not become an integral part of this outermost coating if applied in this way.

The easiest way of including the additional ingredients of this invention in the outermost curable resin coating of the inventive proppant in a manner so that they become an integral part of this outermost coating is simply by adding these additional ingredients to the mill in which inventive proppant is being made after the curable polymer resin is added but while this resin is still molten in form, i.e., before it solidifies.

For this purpose, the additional ingredients of this invention can be added at the same time as one another or shortly before or after one another. In this context, “shortly before” and “shortly after” connote that, while these ingredients need not be added at exactly the same time, they are added close enough in time so that their effect is essentially the same as if they had been added at the same time as one another. Normally, these ingredients will be added separately from one another to prevent them from reacting before being combined with the curable resin of the curable resin coating. In addition, in those instances in which a non-aldehyde functional covalent crosslinking agent and a catalyst for this crosslinking agent are used, the catalyst is desirably added last to prevent premature and/or non-uniform reaction of the non-aldehyde functional covalent crosslinking agent.

In an especially convenient and effective approach, the ingredients forming the outermost curable resin coating are added in the following order: curable polymer resin, conventional aldehyde functional covalent curing agent for the curable polymer resin such as hexa or the like, optional polyol or polyamine organofunctional compound, amino and/or hydroxyl functional nonionic surfactant, non-aldehyde functional covalent crosslinking agent and, finally, the optional catalyst for the non-aldehyde functional covalent crosslinking agent.

In those instances in which a non-aldehyde functional covalent t crosslinking agent is not used, i.e., in the second embodiment of this invention, the non-aldehyde functional covalent crosslinking agent and the catalyst for this crosslinking agent can simply be omitted.

Finally, in those instances in the first embodiment of this invention in which the curable resin coated proppant to be made is intended to cure at temperatures below ˜150° F. (˜66° C.) and the particular non-aldehyde functional covalent crosslinking agent is capable of undergoing rapid reaction with water, an air quench or some other technique for rapidly cooling the proppant after all of the ingredients have been added is desirably used instead of a water quench. On the other hand, if the particular curable resin coated proppant to be made is intended to cure at higher temperatures and/or if the non-aldehyde functional covalent crosslinking agent will not rapidly react with water, a water quench can still be used.

### Improved Oil Permeability

As indicated above, another important feature of the inventive curable resin coated proppant is its relative oil permeability compared with conventional curable resin coated proppants.

Roughly 30 vol. % or so of a typical proppant pack formed from a curable resin coated proppant is composed of void spaces. To this end, an important property of a proppant is its “conductivity,” which is a measure of how easily a hydrocarbon liquid can flow through these void spaces. Proppants exhibiting greater conductivity are more desirable, obviously, since they provide a smaller barrier to the flow of hydrocarbon production fluids passing through the proppant pack during well operation.

However, very few if any hydrocarbon-containing geological reservoirs contain only hydrocarbon fluids such as petroleum, shale oil, natural gas, natural gas liquids and the like. Rather, they almost always also contain aqueous liquids such as naturally-occurring brine water, residual aqueous hydraulic fracturing liquids and the like. As a result, a proppant pack is almost always exposed to both aqueous and hydrocarbon liquids during well operation.

As well appreciated in industry, exposure of a proppant pack to aqueous liquids can significantly decrease its conductivity. This result is believed due to the fact that some of the aqueous liquid passing through the proppant pack becomes trapped in its void spaces, which limits the effective size of the passageways through which the hydrocarbon fluids can flow.

In accordance with another feature of this invention, it has been found that proppant packs formed from the inventive curable resin coated proppant are far less prone to exhibit such decreases in conductivity after exposure to aqueous liquids than conventional curable resin coated proppants. In other words, the inventive curable resin coated proppant exhibits better relative oil permeability than conventional curable resin coated proppants. So, in addition to exhibiting better resistance against clumping above ground and premature consolidation downhole, the inventive proppant of the first embodiment of this invention in which a non-aldehyde functional covalent crosslinking agent is included in its curable resin coating also resists decreases in conductivity after exposure to aqueous liquids downhole as compared with conventional curable resin coated proppants.

In accordance with the second embodiment of this invention, we have further found that, even if the non-aldehyde functional covalent crosslinking agent which is used in the first embodiment of this invention is omitted, curable resin coated proppants made in the manner described above still resist decreases in conductivity after exposure to aqueous liquids downhole in a manner which is far better than that of conventional curable resin coated proppants. Thus, the inventive curable resin coated proppant of this second embodiment also exhibits better relative oil permeability than comparable conventional curable resin coated proppants.

### EXAMPLES

In order to more thoroughly describe this invention, working examples were carried out in which the inventive curable resin coated proppants of this invention were made and subjected to a number of different analytical tests for determining their properties. The following analytical tests were used:

### Crush Strength

This test measures the ability of individual proppant particles to resist catastrophic failure in response to a large applied stress.

About 65 g of proppant is poured into a test cell and a piston is carefully placed into it. A specified amount of pressure (e.g., 8000 psi to 12000 psi) is applied. The pressure is released, and the crushed proppant sample is sieved. The percentage amount of fines generated is measure of the crush strength of the proppant.

### Unconfined Compressive Strength Test

This UCS test measures the ability of a proppant pack formed from a mass of curable resin coated proppants to resist catastrophic failure when exposed to the high temperatures and pressures the proppant will see in its ultimate use location downhole. This test differs from the crush strength test mentioned above in that the former measures the strength of individual proppant particles, while this test is designed to measure the strength of a proppant pack formed from proppant particles which carry a curable resin coating.

To perform this test, a quantity of the proppant to be tested is mixed with a 2% aqueous KCl solution for 5 minutes to simulate the naturally occurring water the proppant will likely see in use downhole. The proppant slurry is then poured into a cylindrical UCS cell assembly, one side of which has a screen to remove any excess liquid while the other side has a sliding piston. The cell assembly so formed is then maintained for a suitable period of time (e.g., 24 hours) at a predetermined temperature (e.g., 250° F./121° C.) and predetermined pressure (e.g., 1,000 psi/6.9 MPa) which simulate the high temperature and pressure the proppant will see in its ultimate use location downhole. This can be done by placing the cell assembly in a furnace at the predetermined temperature and exerting the predetermined pressure on the piston of the cell. In those instances in which a low temperature condition is being simulated, a suitable toughening agent (activator) can be included in the 2% aqueous KCl solution.

In response to these conditions, any liquid remaining in the proppant mass is removed through the screen. In addition, the resin coatings on the individual proppant particles, which have come into intimate contact with one another as a result of the applied pressure, form particle-to-particle bonds as these resin coatings cure. The result is that a specimen is formed in the shape of the UCS cylindrical cell, this specimen being an amalgamated mass of proppant, i.e., a proppant pack.

The specimen so formed is then removed from the UCS cell and placed in an automated press which measures the maximum axial compressive stress the specimen can withstand before catastrophic failure occurs. Note that, in this test, the specimen is unconfined in the sense that its cylindrical walls are free of any support. As a result, the value generated by this test, which is referred to as the unconfined compressive strength of the curable resin coated proppant and which is normally given in psi or MPa, is an accurate measure of the ability of the proppant pack so formed to resist degradation at the simulated conditions of the test.

When measured by this test under the conditions mentioned above, i.e., 24 hours at 250° F./121° C. and 1,000 psi/6.9 MPa, the inventive curable resin coated proppants desirably exhibit UCS values of 300 psi or more, more desirably 400 psi or more or even 500 psi or more. When measured by this test under the conditions which simulate the very low downhole temperature temperatures at which the inventive curable resin coated proppants can be used, e.g.., 24 hours at 70° F./21° C. and 1,000 psi/6.9 MPa, the inventive curable resin coated proppants desirably exhibit UCS values of 10 psi or more, more desirably 15 psi or more or even 25 psi or more.

### Premature Consolidation Test

When charged downhole, some curable resin coated proppants may amalgamate into clumps or masses before they reach their ultimate use locations. This problem, which is known as premature consolidation, normally becomes more significant as downhole temperatures increase. This Premature Consolidation Test can be used to measure the ability of a proppant to resist this premature consolidation problem. For this purpose, this PCT test is carried out to measure whether a particular proppant will consolidate under the influence of elevated temperature only, e.g., 250° F./121° C., without the influence of any added pressure

This PC test is carried out in essentially the same way as the Unconfined Compressive Strength Test mentioned above. However, in this test a simulated temperature of 250° F./121° C. and a simulated pressure of 0 psig is used during the 24 hour test period.

When measured by this test, the inventive curable resin coated proppants desirably exhibit PCT values of 40 psi or less, more desirably 25 psi or less or even 15 psi or less.

### Room Temperature Consolidation Test

The purpose of this RTC test is to measure the ability of a proppant to consolidate into a coherent proppant pack in geological formations having temperatures as low as 70° F. (˜21° C.). It is also carried out in essentially the same way as the UCS Test and the PC Test mentioned above. However, in this test a temperature of 70° F. (˜21° C.) and a simulated pressure of 1,000 psig is used during the 24 hour test period.

### 3-Minute Hot Tensile Test

This 3MT test is normally used to measure whether a curable resin coated proppant has sufficient curability—in other words whether curing of the curable resin coating of this product during manufacture was stopped soon enough to insure that this resin coating is still fully curable. The ability of a curable resin coated proppant to form a strong, coherent proppant pack downhole and hence avoid proppant flowback is due to the bonding of contiguous proppant particles together which, in turn, is due to the fact the resin coatings of contiguous proppant particles undergo substantial cure while they are in intimate contact with one another. It is therefore important that, during manufacture, curing of the curable resin coating of such a product is stopped soon enough so its resin coating is still fully curable. This 3-minute hot tensile test is normally used to measure this property.

In this test, a quantity of the curable resin coated proppant to be tested is poured in a mold, which is then heated without pressure at 450° F. (232° C.) for 3 minutes. The amalgamated proppant mass so formed is then immediately removed from the mold and a tensile force is applied until it breaks. This tensile force or stress, measured in psi, is a measure of the bond strength among contiguous proppant particles and hence a measure of whether the curable resin coating of the proppant exhibits sufficient curability.

In addition to measuring whether a curable resin coated proppant has sufficient curability, this test can also be used to predict whether the inventive curable resin coated proppants will undergo premature consolidation. In particular, because this 3MT test is also carried out without subjecting the proppant to elevated pressure, this test also reflects the tendency of the proppant to consolidate solely in response to elevated temperature.

### Flowability

A problem often encountered with conventional curable resin coated proppants is that they amalgamate or clump together during storage when exposed to the high temperatures and humidities encountered in summertime, especially in Southern states, due to premature cure of their resin coatings. To assess whether a particular curable resin coated proppant may experience this problem, the following flowability test can be performed: 50 grams of proppant in a plastic cup is placed in a humidity chamber set at 125° F. and 90% RH. Visual observation is made about the onset of bonding the cup every hour. The visual observation is classified as:

complete setup—if all the proppant grains have setup into one single pack

clumping—if small clumps of proppant aggregates are visible throughout the sample

free flowing—if there is no visible bonding of proppant grains and all grains completely free flowing

### Leaching Test

Commercial curable novolac resins inherently contain small percentages of unreacted phenols, oligomers and other low molecular weight chemicals. When curable resin coated proppants are made with such resins, these ingredients may leach out into the aqueous liquids these proppants see downhole, including both the hydraulic fracturing fluids used to supply these proppants as well as the naturally occurring aqueous liquids found downhole. This can represent a significant environmental problem, and so it is desirable that a curable resin coated proppant avoid this leaching problem to the greatest extent possible.

To determine the ability of a particular curable resin coated proppant to avoid this leaching problem, the following leaching test can be used. 48 grams of proppant is placed into a 300 ml glass pressure vessel, which is then filled with 200 ml of a 2% potassium chloride aqueous solution. The loaded pressure vessel is then capped and placed in an oven set to 125° F. for 120 hours. To simulate the different conditions that might be encountered downhole, this test is run under three different sets of conditions, one in which the potassium chloride aqueous solution is maintained at an acidic pH (pH=2), the second in which the potassium chloride aqueous solution is maintained at a neutral pH (pH=7), and the third in which the potassium chloride aqueous solution is maintained at an alkaline pH (pH=11). Any free phenol which leaches into the potassium chloride aqueous solution will turn dark red through reaction with the potassium chloride.

Leaching of phenol can also be confirmed quantitatively by extracting the organic content using chloroform and then examining the organic content by NMR (Nuclean Magnetic Resonance) spectrometer.

When determined by this analytical test, the amount of phenol leaching exhibited by the inventive curable resin coated proppants at all three pH levels is desirably 250 ppm or less, more desirably 175 ppm or less and even more desirably 100 ppm or less.

### Comparative Example A

This example represents conventional curable resin coated proppants in that the curable resin coated proppant made in this example comprises two intermediate coating layers of a fully cured novolac resin (including residual hexa, if any) and a final outer coating layer made from a curable novolac resin and a hexa curing agent.

After being heated in a calciner to a temperature of about 550° F. (˜288° C.), 20 pounds (˜9 kg) of northern white sand was placed in a continuously operating pug mill. When the temperature of the sand had dropped to about 450° F. (232° C.), 3 g of a silane coupling agent in water was added followed by the addition of ˜79 grams of a commercially available solid particulate novolac resin and ˜28 grams of hexamethylenetetramine (“hexa”) in the form of a 40% aqueous solution with continuous vigorous mixing. As a result, a first intermediate coating layer comprising a fully cured novolac resin was formed on the proppant particle substrate. Shortly thereafter, when the temperature of the proppant had dropped to about 375° F. (190° C.), the above procedure was repeated, thereby forming a second intermediate coating layer also comprising a fully cured novolac resin.

Shortly thereafter, the above procedure was repeated once again, except in this case a polyethylene glycol toughening agent in the amount of 3.8 wt % BOR was added along with the other ingredients forming this third and last coating layer. Moreover, by this time the ingredients forming this layer were applied, the temperature of the proppant had dropped to about 325° F. (162° C.).

As soon as the newly added novolac resin forming this third and final coating layer had melted to form a uniform coating on the previously made resin coated proppant particle substrate, the proppant was rapidly quenched with water to below 100° F. (˜38° C.), thereby producing a final coating layer comprising a curable novolac resin. The product so formed was then sieved to remove any clumps or agglomerates that may have formed, thereby producing the final product, i.e., a curable resin coated proppant comprising a proppant particle substrate composed of northern white sand, two intermediate coating layers on the substrate composed of a fully cured novolac resin and a final outer coating layer composed of a curable novolac resin and a polyol toughening agent, with the total amount of novolac resin in this product being 2.6 wt. % BOS, i.e., based on the weight of the sand.

### Comparative Example B

This example represents the inventive proppants of our earlier patent disclosure mentioned above in which a polyol organofunctional compound and a covalent crosslinking agent are included in the outer curable resin coating of a curable resin coated proppant.

Comparative Example A was repeated, except that after the novolac resin forming the outing coating layer had melted and uniformly coated the previously formed resin coated proppant particle substrate and immediately after the hexa was added but before this product was rapidly quenched to below 100° F. (˜38° C.), a polyethylene glycol organofunctional compound in the amount of 3.8 wt % based on the weight of the resin in the outer coating layer, a p-MDI covalent crosslinking agent in the amount of 0.2 wt. % BOS, and a tertiary amine catalyst in the amount of 10 wt. %, based on the weight of the p-MDI, were added.

### Examples 1 to 6

Comparative Examples A and B were repeated, except that after the novolac resin forming the outing coating layer had melted and uniformly coated the previously formed resin coated proppant particle substrate and immediately after the hexa was added but before this product was rapidly quenched, a hydroxyl functional nonionic surfactant (octylphenol ethoxylate) in the amount of 0.5 wt. % BOS, a p-MDI covalent crosslinking agent in the amount of 0.2-0.5 wt. % BOS and a tertiary amine catalyst in the amount of 10 wt. % based on the weight of the p-MDI were added in a successive manner. In addition, in Examples 4-6, 3.5 wt % based on the weight of the resin in the outer coating layer of a polyethylene glycol organofunctional compound having a molecular weight enabling it to also function as a toughening agent was added immediately before the nonionic surfactant was added. Moreover, in some of these examples the amount of novolac resin used was 3 wt. % BOS rather than 2.6 wt. % as in the case of Comparative Examples A and B. Furthermore, in still other of these working examples, different commercially available novolac resins were used. For convenience, we refer to them as Resin Types 1, 2 and 3 in the following discussion and tables.

The curable resin coated proppants obtained in each of the above examples, including Comparative Examples A and B, were analyzed by four of the analytical tests described above. The results obtained are set forth in the following Table 1:

TABLE 1
Composition and Properties of Inventive Proppants

| | | | | | | | UCS, | PCT, | 3MT, |
|---|---|---|---|---|---|---|---|---|---|
| | | | | | | | psi | psi | psi |
| | Resin | | | Tough | Nonionic | Crush | (1k psi | (0 psi | (0 psi |
| | | Amount, | p-MDI, | Agent, | Surfact, | Streng, | 250 F. | 250 F. | 450 F. |
| Example | Type | % BOS | % BOS | % BOR | % BOS | % fines | 24 hr) | 24 hr) | 3 min) |
| A | 1 | 2.6 | 0 | 3.8 | 0 | 5.9 | — | 100 | 120 |
| B | 1 | 2.6 | 0.2 | 3.8 | 0 | 5.66 | 364 | 31 | 14 |
| 1 | 1 | 1.5 | 0.5 | 0 | 0.5 | 4.00 | 422 | 6 | 5 |
| 2 | 1 | 2.0 | 0.5 | 0 | 0.5 | 6.20 | 65 | 8 | 4 |
| 3 | 1 | 2.0 | 0.5 | 0 | 0.5 | 2.68 | 823 | 6 | 3 |
| 4 | 1 | 1.5 | 0.5 | 3.5 | 0.5 | 5.76 | 151 | 14 | 4 |
| 5 | 1 | 2.0 | 0.5 | 3.5 | 0.5 | 3.17 | 545 | 5 | 5 |
| 6 | 1 | 2.6 | 0.5 | 3.5 | 0.5 | 2.14 | 888 | 4 | 6 |

From Table 1, it can be seen that the crush strength of the inventive proppants in most cases is almost as good as that of the comparative proppants in most instances and even better in some instances. In addition, it can also be seen that all of the inventive proppants (as well as the inventive proppant of our earlier disclosure) exhibit substantial UCS values, indicating that they will all form strong, coherent proppant packs when exposed to elevated temperatures downhole of ˜250° F. (˜121° C.) and higher as well as the elevated pressures normally encountered there. Furthermore, the variance in UCS values among the proppants of Examples 4, 5 and 6 suggests that proppant pack strength can be controlled by controlling the amount of resin used to make the curable resin layer, while the variance in the UCS values of Examples 1, 2 and 4 suggests that variations in cooling rate of the curable resin coating can also affect the UCS values obtained. In particular, these examples suggest that rapid cooling of this curable resin coating will lead to an increased UCS, while slower cooling will lead to a reduction in UCS since it enables a greater amount of curing to occur before cooling is complete. In addition, the very high UCS values exhibited by the proppants of Example 3 and 6 suggest that these proppants will form especially strong proppant packs.

Meanwhile, Table 1 further shows that the PCT and 3MT values of the inventive proppants of Examples 1-6 (as well as the inventive proppant of our earlier disclosure reproduced in Comparative Example B) are much lower than the PCT and 3MT values of the conventional proppant of Comparative Example A. This indicates that the inventive proppant (as well as the inventive proppant of our earlier disclosure), will not undergo premature cure downhole when exposed to elevated temperatures downhole of ˜250° F. (˜121° C.) and higher as well as the elevated pressures normally encountered there.

### Comparative Example C and Examples 7 to 10

Examples 1 to 6 were repeated, except that rapid quenching to below 100° F. (˜38° C.) was done using an air quench instead of a water quench.

TABLE 2
Composition and Properties of Inventive Proppants

| | | | | | | | UCS | |
|---|---|---|---|---|---|---|---|---|
| | Resin | | p- | Tough | Nonionic | Crush | 1K | |
| | | Amount, | MDI, % | Agent, % | Surfact, | Strength, | psi | 3MT, |
| Example | Type | % BOS | BOS | BOR | % BOS | % fines | 75° F. | psi |
| C | 1 | 2.0 | 0.5 | 3.5 | 0 | 5.43 | 0 | 4 |
| 7 | 1 | 2.0 | 0.4 | 3.5 | 0.5 | 5.5 | 12 | 4 |
| 8 | 3 | 2.0 | 0.4 | 3.5 | 0.5 | 5.8 | 16 | 3 |
| 9 | 1 | 2.0 | 0.4 | 3.5 | 0.5 | 4.4 | 34 | 5 |
| 10 | 3 | 2.0 | 0.4 | 3.5 | 0.5 | 5.7 | 30 | 4 |

Comparative Example C is another example illustrating the inventive proppants of our earlier patent disclosure mentioned above in which a polyol organofunctional compound and a covalent crosslinking agent are included in the curable resin coating layer of a curable resin coated proppant. As can be seen from Table 2, the curable resin coated proppant of this example exhibited an RTC (room temperature consolidation) test value of 0 psi. This indicates that a proppant pack would not form from this particular proppant at a downhole temperature of 70° F. (˜21° C.) even if subjected to an elevated pressure such as 1,000 psig for an extended period of time.

In contrast, however, all of the inventive proppants of Examples 7 to 10 exhibited UCS values of 12 psi or more. Generally speaking, a UCS value of above 10 psi for a particular proppant suggests that the bond strength of the proppant pack formed by that proppant will be sufficient to prevent proppant pack degradation and the proppant flowback which such degradation causes. That being the case, the data in Table 2 shows that the inventive curable resin coated proppants can be made in such way as to be effective in forming strong, coherent proppant packs at downhole temperatures as low as 70° F. (˜21° C.).

### Comparative Examples D, E and F and Examples 11 and 12

The purpose of these examples is to compare the inventive proppants with conventional curable resin coated proppants in terms of their relative oil permeabilities, i.e., the permeability of a proppant pack formed from these proppants to liquid hydrocarbon flow after having been first flushed with an aqueous liquid.

All of the proppants in these examples were made with 30/50 mesh NW sand as the proppant particle substrate. The proppants of Examples 11 and 12 were made by the general procedure of Examples 1 to 6, except that the proppant of Example 11 was made with only one intermediate coating layer of a fully cured novolac resin. In both of these examples, the amount of the polyethylene glycol organofunctional compound used was 3.5 wt % based on the weight of the resin in the outer coating layer, the amount of the nonionic surfactant (ctylphenol ethoxylate) used was 0.5 wt. % BOS, the amount of the p-MDI covalent crosslinking agent used was 0.5 wt. % based on the weight of the sand in the proppant and the amount of the tertiary amine catalyst used was 20 wt. % based on the weight of the p-MDI.

Meanwhile, for purposes of comparison, the proppant of Comparative Example D was composed solely of NW sand, while the proppant of Comparative Example E was a conventional curable resin coated proppant supplied by a competitor of the assignee of this disclosure. Finally, the proppant of Comparative Example F was a conventional curable resin coated proppant supplied by the assignee of this disclosure.

### Relative Oil Permeability Test

The relative oil permeabilities of these proppants were measured by the following method. Six hundred fifty grams of proppant was weighed into a scoop and wet with deionized water until damp. The damp proppant was then loaded into a Constant Head Permeameter (Humboldt Test Equipment) in accordance with ASTM D2434 (Standard Test Method for Permeability of Granular Soils). The average pore volume of the resulting proppant pack was calculated to be about 35 percent of the proppant material volume.

Once the permeameter cell was loaded, the inlet was connected to a 200 gph pump submerged in a five gallon bucket of a 2 wt. % KCl aqueous solution, which is used to simulate the naturally occurring water the proppant will likely see in use downhole. The outlet of the cell was then piped back into the bucket in such a manner as to allow the KCl aqueous solution to continuously recirculate through the pack. This aqueous recirculation procedure was continued for 24 hours as a means to thoroughly wet the proppant and wash off any residual surfactants.

After completing this wash step, the permeameter cell was connected to a 1 L funnel by means of a flexible tube in accordance with ASTM D2434 (Standard Test Method for Permeability of Granular Soils). The cell was then laid horizontally on a pair of laboratory jack stands at a height such that the distance between the cell outlet and the level of the KCl aqueous solution in the funnel was 10 centimeters. The aqueous solution that flowed through the pack at this head height was collected and measured every 120 seconds for a 480 second time period. The aqueous solution level in the funnel was kept constant by means of spigoted bucket on a laboratory jack stand placed next to the apparatus.

This procedure was repeated for head heights of 12, 14, 16, 18 and 21 centimeters. From this data, a Coefficient of Absolute Permeability (k) was calculated from the slope of μqL/A plotted as a function of ΔP.

After the Coefficient of Absolute Permeability of the pack was calculated, the Effective Permeability of the proppant pack to Isopar™ G fluid was determined. “Isopar™ G fluid is a synthetic isoparaffinic hydrocarbon solvent, commercially available from ExxonMobil Chemical, used to simulate the surface characteristics of petroleum. Meanwhile, the Effective Permeability to Isopar™ G fluid in this context means the permeability of the proppant pack to Isopar™ G after the proppant pack had first been flushed with the KCl aqueous solution.

To determine the Effective Permeability of the proppant pack to Isopar™ G fluid, the head height of the apparatus was adjusted to 18 cm and the funnel refilled with Isopar™ G fluid. The fluid that flowed through the pack at this head height was collected and measured every 60 seconds until the flow rate of Isopar G was constant.

Using Darcy's Equation, this data was used to calculate the Effective Permeability of Isopar G through the proppant pack, i.e., the intrinsic permeability, x, of the aqueous KCl-modified proppant pack. By dividing the Effective Permeability of Isopar G by the Coefficient of Absolute Permeability (k), the Relative Permeability of Isopar G through the proppant pack at different pressure drops can be obtained. These Relative Permeability values could then be used to compare different proppant samples to another at different pressure drops, i.e., at different closure pressures. The higher the Relative Permeability, the higher the Isopar G flow at a given pressure drop (ΔP).

The results obtained are set forth in the following Table 3:

TABLE 3
Relative Permeabilities of the Inventive and Comparative
Proppants to Isopar G at an 8,000 psi Pressure
Drop Before and After a 2% KCl Wash for 96 hours

| | | Relative | | Crush | UCS |
|---|---|---|---|---|---|
| | | Permeability | | Strength, | 1000 psi, |
| Ex- | | Before | After | 8,000 psi, | 250° F., |
| ample | Description | KCl Wash | KCl Wash | % fines | 24 hours |
| D | sand only | 0.17 | 0.16 | 9.8 | 0 |
| E | competitive product | 0.59 | 0.20 | 2.6 | 104 |
| F | commercial product | 0.37 | 0.17 | 5.0 | 331 |
| 11 | 1.5 wt. % resin | 0.63 | 0.50 | 2.6 | 423 |
| | BOS | | | | |
| 12 | 2.0 wt. % resin | 0.50 | 0.55 | 2.1 | 810 |
| | BOS | | | (10k psi) | |

Table 3 shows the inventive proppants of Examples 11 and 12 exhibit relative permeabilities to Isopar™ G which are significantly higher than those of raw sand or conventional curable resin coated proppants. In particular Table 3 shows that the modification to the surface of a curable resin coated proppant which is achieved by this invention increases the relative permeability of a proppant pack made from such a proppant to Isopar™ G by at least 100% compared to conventional curable resin coated proppants.

To appreciate the significance of this achievement, consider the competitive proppant. At an 8,000 psi closure stress, this proppant has a conductivity of 428 md·ft. However, its relative permeability to Isopar™ G is 0.59 before KCl wash and 0.2 after the KCl wash. Therefore, the effective conductivity of this competitive proppant to oil will likely be on the order of 253 md·ft initially and 86 md·ft in the long term.

In contrast, under similar conditions, the inventive proppant of Example 11 has a conductivity of 572 md·ft. However, because this proppant has a relative permeability to Isopar™ G of 0.63 before washing and 0.5 in the long term, the effective conductivity to oil of this proppant will likely be on the order of 360 md·ft initially and 286 md·ft in the long term.

It will therefore be appreciated that the surface modifications made possible by this invention result in new curable resin coated proppants which can achieve very real and substantial increases in the effective conductivities of these proppants (i.e., the conductivities these proppants exhibit in actual use environments downhole) relative to conventional proppants of this type.

Although only a few embodiments of this invention have been described above, it should be appreciated that many modifications can be made without departing from the spirit and scope of this invention. All such modifications are intended to be included within the scope of this invention, which is to be limited only by the following claims:

1. A curable resin coated proppant which comprises a proppant particle substrate and a curable resin coating on the proppant particle substrate, wherein the curable resin coating comprises the reaction product obtained when a molten mixture comprising a curable polymer resin, an aldehyde functional covalent curing agent for the curable polymer resin, and a nonionic surfactant having reactive functionality due to one or more hydroxyl groups, one or more amino group or both is coated onto the proppant particle substrate and then solidified in a manner so that the curable polymer resin remains curable.

2. The curable resin coated proppant of claim 1, wherein the nonionic surfactant is a polyethoxylated nonionic.

3. The curable resin coated proppant of claim 2, wherein the polyethoxylated nonionic includes a hydrophilic section which comprises 5 to 30 polymerized ethylene oxide units.

4. The curable resin coated proppant of claim 2, wherein the polyethoxylated nonionic includes a hydrophobic (lipophilic) section which is an alkyl benzene whose alkyl group contains 5 to 20 carbon atoms, this polyethoxylated nonionic also including a hydrophilic section which comprises 7 to 30 polymerized ethylene oxide units.

5. The curable resin coated proppant of claim 4, wherein the polyethoxylated nonionic includes a hydrophobic (lipophilic) section which is an alkyl benzene whose alkyl group contains 8 to 12 carbon atoms, this polyethoxylated nonionic also including a hydrophilic section which comprises 12 to 20 polymerized ethylene oxide units.

6. The curable resin coated proppant of claim 2, wherein the polyethoxylated nonionic includes a hydrophobic section which is derived from a fatty acid containing 8 to 24 carbon atoms, this polyethoxylated nonionic also including a hydrophilic section which comprises 8 to 24 polymerized ethylene oxide units.

7. The curable resin coated proppant of claim 2, wherein the nonionic surfactant is octylphenol ethoxylate.

8. The curable resin coated proppant of any-preceding claim 1, wherein the molten mixture further comprises a non-aldehyde functional covalent crosslinking agent for the curable polymer resin and an optional catalyst for the non-aldehyde functional covalent crosslinking agent.

9. The curable resin coated proppant of claim 8, wherein the non-aldehyde functional covalent crosslinking agent is selected from the group consisting of epoxides, anhydrides, aldehydes, diisocyanates, carbodiamides, divinyl compounds and diallyl compounds.

10. The curable resin coated proppant of claim 9, wherein the non-aldehyde functional covalent crosslinking agent is a diisocyanate.

11. The curable resin coated proppant of claim 10, wherein the diisocyanate is at least one of toluene-diisocyanate, naphthalenediisocyanate, xylene-diisocyanate, tetramethylene diisocyanate, hexamethylene diisocyanate, trimethylene diisocyanate, trimethyl hexamethylene diisocyanate, cyclohexyl-1,2-diisocyanate, cyclohexylene-1,4-diisocyanate, a diphenylmethanediisocyanate and an isocyanate-terminated polyurethane prepolymer.

12. The curable resin coated proppant of claim 11, wherein the diisocyanate is a mixture of diphenylmethanediisocyanates.

13. The curable resin coated proppant of claim 8, wherein the curable resin coating further comprises an organofunctional compound selected from the group consisting of a polyol and a polyamine.

14. The curable resin coated proppant of claim 13, wherein the organofunctional compound is a polyol.

15. The curable resin coated proppant of claim 14, wherein the polyol exhibits a plasticizing effect on the curable polymer resin.

16. The curable resin coated proppant of claim 15, wherein the polyol is a hydroxyl terminated polyethylene glycol or a hydroxyl terminated polypropylene glycol.

17. The curable resin coated proppant of claim 1, wherein the curable polymer resin is a phenol aldehyde resin.

18. The curable resin coated proppant of claim 17, wherein the phenol aldehyde resin is a novolac resin.

19. The curable resin coated proppant of claim 1, wherein the molten mixture comprises a novolac resin, a hexmethalenetetramine curing agent for the novolac resin, and a polyethoxylated nonionic surfactant.

20. The curable resin coated proppant of claim 19, wherein the molten mixture further comprises a diisocyanate non-aldehyde functional covalent crosslinking agent.

21. The curable resin coated proppant of claim 20, wherein the molten mixture further comprises an organofunctional compound comprising a hydroxyl terminated polyethylene glycol, a hydroxyl terminated polypropylene glycol or both.

22. The curable resin coated proppant of claim 21, wherein the molten mixture further comprises a catalyst for the diisocyanate non-aldehyde functional covalent crosslinking agent.

23. The curable resin coated proppant of claim 1, wherein the curable resin coated proppant exhibits a UCS value of 10 psi or more, when measured by the UCS analytical test described in the specification carried out under the conditions of 70° F./21° C. and 1,000 psi/6.9 MPa for 24 hours.

24. The curable resin coated proppant of claim 1, wherein the curable resin coated proppant exhibits a PCT value of 40 psi or less when measured by the PCT analytical test described in the specification carried out under the conditions of 250° F./121° C. and 0 psi for 24 hours.

25. The curable resin coated proppant of claim 1, wherein the amount of phenol leaching exhibited by the inventive curable resin coated proppant when subjected to the phenol leaching analytical test described in the specification is less than 100 ppm at pH=2 and at pH=7 and at pH=11.

26. An aqueous fracturing fluid comprising an aqueous carrier liquid and the curable resin coated proppant of claim 1.

27. A method of fracturing a geological formation comprising pumping into the formation the fracturing fluid of claim 26.

28. A curable resin coated proppant which comprises a proppant particle substrate and a curable resin coating on the proppant particle substrate, wherein the curable resin coating comprises a curable polymer resin, an aldehyde functional curing agent for the curable polymer resin, a nonionic surfactant having reactive functionality due to one or more hydroxyl groups, one or more amino group or both, a non-aldehyde functional covalent crosslinking agent for the curable polymer resin, and a catalyst for the non-aldehyde functional covalent crosslinking agent which is added to the curable resin coating after the nonionic surfactant and covalent crosslinking agent are added.
